(19) United States
(12) Patent Application Publication
(10) Pub. No.: US 2026/0123597 A1
(43) Pub. Date: May 7, 2026

(54) CONTROL METHOD, DEVICE AND SYSTEM FOR FECES CLEANING SYSTEM

(71) Applicant: Shenzhen Petsuper Smart Technology Co., Ltd., Shenzhen (CN)

(72) Inventors: Kaiyang Hu, Shenzhen (CN); Jingli Wei, Shenzhen (CN)

(21) Appl. No.: 19/263,552

(22) Filed: Jul. 9, 2025

(30) Foreign Application Priority Data
Nov. 1, 2024 (CN) 202411552693.5

(51) Int. Cl. A01K 1/01; B08B 3/02

(52) U.S. Cl. CPC A01K 1/0114; B08B 3/02

(57) ABSTRACT

The present disclosure provides a control method, device and system for a feces cleaning system. Relating to the technical field of pet supplies. The control method includes: determining a current state through a weighing sensing module and an infrared sensing module; when the current state is a state where toileting is completed, executing a screening and cleaning process; opening an opening of the connected garbage bag and corresponding it to a position of a discharge outlet of the device; after the screening and cleaning process is completed, closing the opening of the garbage bag that receives the feces clumps by a sealing device. The control method of the feces cleaning system provided in the present disclosure improves the feces cleaning efficiency through automation technology, ensures that feces falls directly into the garbage bag, reduces environmental pollution and odor emission, and improves air quality and living comfort.

### CROSS-REFERENCE TO RELATED APPLICATION

The present disclosure claims priority to Chinese patent application No. 202411552693.5, filed with the Chinese Patent Office on Nov. 1, 2024, the entire contents of which are incorporated herein by reference.

### TECHNICAL FIELD

The present disclosure relates to the technical field of pet supplies, and in particular to a control method, device and system for a feces cleaning system.

### BACKGROUND ART

With the development of society and the improvement of living standards, people's pursuit of quality of life is also constantly improving. In the field of pet care, pet cats, as important members of the family, are also valued for their quality of life. The optimization of modern living area planning and the improvement of pet care requirements have made the living environment and sanitary conditions of pet cats the focus of attention. However, the fast-paced lifestyle has made pet owners face challenges in pet sanitation management, especially in the cleaning and maintenance of cat toilets.

Although the existing cat toilet technology has achieved automation to a certain extent, it can automatically perform the cleaning process and reduce the burden on pet owners. These technologies usually include functions such as automatic cleaning of feces and automatic replenishment of cat litter in order to achieve the effect of freeing hands. However, despite the progress made in automation, these technologies still have deficiencies in feces treatment and odor control.

Specifically, before and after the cleaning process of cat toilets in the prior art, feces are often exposed to the air for a long time, resulting in the continuous emission of feces odor in the space where the cat litter box is located, causing the deterioration of environmental sanitation. This continuous odor emission not only affects the comfort of the living environment, but also may attract insects to enter and lay eggs, further exacerbating environmental pollution. In addition, the long-term presence of fecal odor may also have potential impacts on human health and the physical health of pet cats, especially in confined or poorly ventilated spaces.

In summary, although the existing cat toilet technology has made some progress in automated cleaning, it has obvious defects in odor control and environmental sanitation management. These problems not only affect the quality of life of pet owners, but also pose challenges to the health of pet cats and the sanitation condition of the home environment. Therefore, it is necessary to develop a new cat toilet technology to solve the odor control and environmental sanitation problems in the prior art and improve the overall experience of pet care.

### SUMMARY

In the first aspect, the present disclosure provides a control method for a feces cleaning system, comprising:
determining a current state through a weighing sensing module and an infrared sensing module;
when the current state is a state where toileting is completed, controlling a cleaning device to perform a screening and cleaning process;
controlling a sealing device to open an opening of a connected garbage bag, and make it correspond to a position of a discharge outlet of the cleaning device, so as to receive feces clumps discharged through the discharge outlet of the cleaning device through the opened opening of the garbage bag; and
after the screening and cleaning process is completed, closing the opening of the garbage bag that has received the feces clumps by the sealing device.

In an optional embodiment, the determining a current state through a weighing sensing module and an infrared sensing module comprises:
determining whether there is exogenous foreign object entering a target region through the infrared sensing module;
if yes, confirming the current state through the weighing sensing module;
if no, returning to execute the determining whether there is exogenous foreign object entering a target region through the infrared sensing module.

In an optional embodiment, the confirming the current state through the weighing sensing module comprises:
using a last weighing data before the entry of exogenous foreign object as a first benchmark data through the weighing sensing module; and within a first preset time range, acquiring a current first measured weight data;
based on the first benchmark data and the first measured weight data, determining a first weight change data within the first preset time range;
when the weight change data is not less than a first preset weight threshold, determining the current state is a state where toileting is performing;
in the state where toileting is performing, within a second preset time range, acquiring a current second measured weight data;
based on the second measured weight data and the first benchmark data, determining a second weight change data within the second preset time range; and
when the second weight change data is not greater than a second preset weight threshold, determining the current state is the state where toileting is completed.

In an optional embodiment, the controlling a sealing device to open an opening of a connected garbage bag, and make it correspond to a position of a discharge outlet of the cleaning device comprises:
acquiring a monitoring image of a cleaning work region through a first image acquisition device;
determining a position of the discharge outlet of the cleaning device according to the monitoring image; and
when the discharge outlet enters the cleaning work region, controlling the sealing device to open the opening of the garbage bag and correspond the opening of the garbage bag to the position of the discharge outlet.

In an optional embodiment, the controlling the sealing device to open the opening of the garbage bag and correspond the opening of the garbage bag to the position of the discharge outlet comprises:
acquiring an outlet information of the discharge outlet in the monitoring image, wherein the outlet information comprises an area size of a region of the discharge outlet and current contour coordinates of the discharge outlet;
determining a target opening size of the garbage bag according to the area size of the region, and opening the opening of the garbage bag to reach the target opening size through the sealing device, wherein the opening size of the garbage bag is not less than the area of the region; and
determining a matching position corresponding to the opening of the garbage bag according to the current contour coordinates, so as to move the opening of the garbage bag to the matching position through the sealing device.

In an optional embodiment, after the controlling a cleaning device to perform a screening and cleaning process, it further comprises:
acquiring a working current of the cleaning device and a reset switch state;
when the working current is greater than a preset current threshold, and the reset switch state is a state that a preset position signal is not detected, determining there is a foreign object stuck in the cleaning device, and stopping an executing of the screening and cleaning process, and returning to execute the acquiring a working current of the cleaning device and a reset switch state.

In an optional embodiment, the control method of the feces cleaning system further comprises:
monitoring of a remaining amount of cat litter in a storage bin in real time by a first TOF sensing module;
when the remaining amount of cat litter is less than a preset remaining amount threshold, determining a current remaining amount of cat litter is unqualified, and controlling a litter adding motor reducer to replenish the cat litter in the storage bin based on a replenishment duration;
after the replenishment duration, controlling the storage bin to smooth the cat litter therein, and returning to execute the monitoring of a remaining amount of cat litter in a storage bin in real time by a first TOF sensing module; and
when the remaining amount of cat litter is not less than the preset remaining amount threshold, determining the current remaining amount of cat litter is qualified.

In an optional embodiment, before the closing the opening of the garbage bag that has received the feces clumps by the sealing device, it further comprises:
controlling an exhaust device to lay a bottom of the garbage bag flat in a storage space of the garbage bag;
using a second image acquisition device to determine a height of the feces clumps in the garbage bag, plane feces clumps coordinates of a plane where the feces clumps are located, and a volume of the feces clumps;
controlling a spray device to insert into the garbage bag and reach a vertical spray height, wherein the spray height is higher than the height of the feces clumps;
controlling a nozzle of the spray device to an inclination angle corresponding to the plane feces clumps coordinates;
determining a spray dosage according to the volume of the feces clumps;
controlling the nozzle to spray the feces clumps with deodorant liquid based on the spray dosage; and after the spray is completed, controlling the spray device to move out of the garbage bag.

In the second aspect, the present disclosure provides a control device for a feces cleaning system, comprising:
a detection module, used to determine a current state through a weighing sensing module and an infrared sensing module;
a cleaning module, used to control a cleaning device to perform a screening and cleaning process when the current state is a state where toileting is completed;
an adjustment module, used to control a sealing device to open an opening of a connected garbage bag, and make it correspond to a position of a discharge outlet of the cleaning device, so as to receive the feces clumps discharged through the discharge outlet of the cleaning device through the opened opening of the garbage bag; and
a sealing module, used to close the opening of the garbage bag that has received the feces clumps through the sealing device after the screening and cleaning process is completed.

In the third aspect, the present disclosure provides a control system for a feces cleaning system, the control system for the feces cleaning system comprising a processor and a memory, the memory storing a computer program, and the processor executing the computer program to implement the control method of the feces cleaning system described in any one of the aforementioned embodiments.

The control method of the feces cleaning system of the present disclosure embodiment realizes the accurate collection and processing of feces through automation technology, significantly improving environmental sanitation and living comfort. This method controls the sealing device to accurately match the opening of the garbage bag with the discharge outlet of the cleaning device, ensuring that the feces falls directly into the garbage bag, avoiding the spillage of feces due to inaccurate opening position, and reducing the risk of environmental pollution. At the same time, the opening of the garbage bag is only opened when the screening and cleaning process is executed, which effectively prevents the feces clumps from being exposed to the air, reduces the continuous emission of odor, and improves the air quality of the surrounding environment. In addition, the system closes the opening of the garbage bag after the cleaning process is completed, further isolating the feces clumps from contact with the outside air, preventing the emission of odor, and improving the comfort of the living environment. This intelligent control method not only reduces the health risks of pets and family members, but also reduces maintenance costs and difficulties, and improves the overall satisfaction of pet owners with the feces cleaning system.

### BRIEF DESCRIPTION OF DRAWINGS

In order to more clearly illustrate the technical solution of the present disclosure, the following is a brief introduction to the drawings required for use in the embodiments. It should be understood that the following drawings only show some embodiments of the present disclosure and should not be regarded as limiting the scope of protection of the present disclosure. For those ordinary skilled in the art, other relevant drawings can also be obtained based on these drawings without creative work.

FIG. 1 is a structural schematic diagram of the hardware operating environment involved in the embodiment of the control method of the feces cleaning system of the present disclosure;

FIG. 2 is a flow diagram of embodiment 1 of the control method of the feces cleaning system of the present disclosure;

FIG. 3 is a flow diagram of the refinement of step S100 in embodiment 2 of the control method of the feces cleaning system of the present disclosure;

FIG. 4 is a flow diagram of the refinement of step S120 in embodiment 2 of the control method of the feces cleaning system of the present disclosure;

FIG. 5 is a flow diagram of the refinement of step S300 in embodiment 2 of the control method of the feces cleaning system of the present disclosure;

FIG. 6 is a flow diagram of the refinement of step S330 (S111-S115) in embodiment 2 of the control method of the feces cleaning system of the present disclosure;

FIG. 7 is a flow chart of steps S500-1˜S500-2 in embodiment 3 of the control method of the feces cleaning system of the present disclosure;

FIG. 8 is a flow chart of steps S600-1˜S600-4 in embodiment 3 of the control method of the feces cleaning system of the present disclosure;

FIG. 9 is a flow chart of steps S700-1˜S700-2 in embodiment 4 of the control method of the feces cleaning system of the present disclosure;

FIG. 10 is a module connection diagram of the control device of the feces cleaning system in the embodiment of the present disclosure.

### DETAILED DESCRIPTION OF EMBODIMENTS

The following will clearly and completely describe the technical solutions in the embodiments of the present disclosure in combination with the drawings in the embodiments of the present disclosure. Obviously, the described embodiments are only part of the embodiments of the present disclosure, not all of the embodiments.

The components of the embodiments of the present disclosure described and shown in the drawings here can be arranged and designed in various different configurations. Therefore, the following detailed description of the embodiments of the present disclosure provided in the drawings is not intended to limit the scope of protection claimed the present disclosure, but only represents the selected embodiments of the present disclosure. Based on the embodiments of the present disclosure, all other embodiments obtained by those skilled in the art without creative work are within the scope of protection of the present disclosure.

In the following, the terms “including”, “having” and their cognates that can be used in various embodiments of the present disclosure are only intended to indicate specific features, numbers, steps, operations, elements, components or combinations of the foregoing items, and should not be understood as first excluding the existence of one or more other features, numbers, steps, operations, elements, components or combinations of the foregoing items or increasing the possibility of one or more features, numbers, steps, operations, elements, components or combinations of the foregoing items.

In addition, the terms “first”, “second”, “third”, etc. are only used to distinguish the description and cannot be understood as indicating or implying relative importance.

Unless otherwise defined, all terms (including technical terms and scientific terms) used herein have the same meaning as those generally understood by those ordinary skilled in the art to which the various embodiments of the present disclosure belong. The terms (such as those defined in generally used dictionaries) will be interpreted as having the same meaning as the contextual meaning in the relevant technical field and will not be interpreted as having an idealized meaning or an overly formal meaning unless clearly defined in the various embodiments of the present disclosure.

It should be understood that the specific embodiments described herein are only used to explain the present disclosure and are not used to limit the present disclosure.

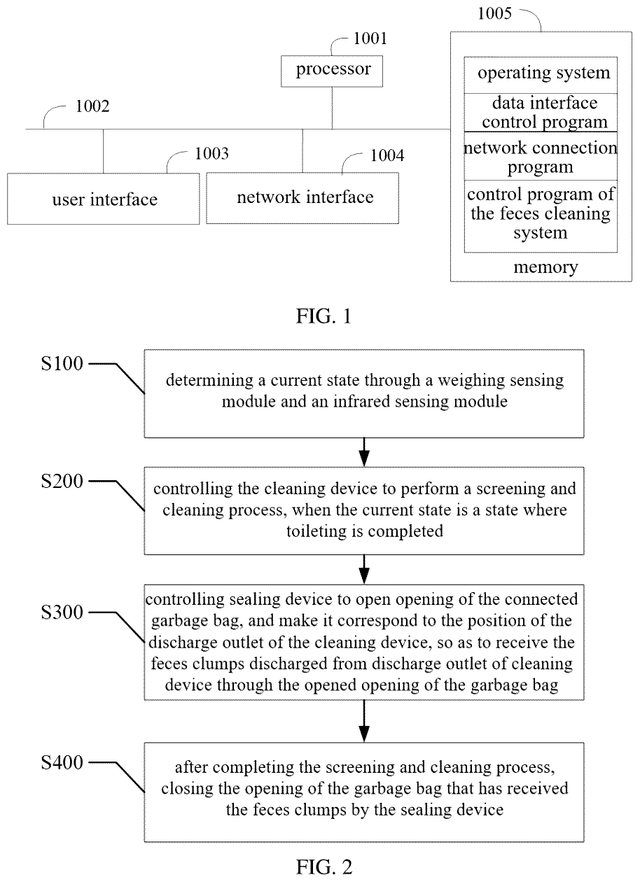

As shown in FIG. 1, it is a structural schematic diagram of the hardware operating environment of the terminal involved in the embodiment of the present disclosure.

The control system of the feces cleaning system provided in the embodiment of the present disclosure can be a PC, or a mobile terminal device such as a smart phone, a tablet computer or a portable computer. The control system of the feces cleaning system may include: a processor 1001, such as a CPU, a network interface 1004, a user interface 1003, a memory 1005 and a communication bus 1002. The communication bus 1002 is used to realize the connection and communication between these components. The user interface 1003 may include a display screen, an input unit such as a keyboard, a remote control, and optionally, the user interface 1003 may also include a standard wired interface and a wireless interface. The network interface 1004 may optionally include a standard wired interface and a wireless interface (such as a WI-FI interface). The memory 1005 may be a high-speed RAM memory or a stable memory, such as a disk memory. Optionally, the memory 1005 may also be a storage device independent of the aforementioned processor 1001. Optionally, the control system of the feces cleaning system may also include an RF (Radio Frequency) circuit, an audio circuit, a WiFi module, and the like.

Those skilled in the art may understand that the control system of the feces cleaning system shown in FIG. 1 does not constitute a limitation thereto, and may include more or fewer components than shown in the figure, or combine the components, or arrange components differently. As shown in FIG. 1, the memory 1005 as a computer-readable storage medium may include an operating system, a data interface control program, a network connection program, and a control program of the feces cleaning system.

The following is a detailed description of some embodiments of the present disclosure in combination with the drawings. In the absence of conflict, the following embodiments and features in the embodiments may be combined with each other.

### Embodiment 1

Referring to FIG. 2, embodiment 1 of the present disclosure provides a control method for feces cleaning system, comprising following steps.

Step S100, determining a current state through a weighing sensing module and an infrared sensing module.

As mentioned above, the weighing sensing module is used to detect whether there is a weight change of an object (such as a pet), and the infrared sensing module detects the movement and existence of the object. This step is intended to determine whether the pet has entered the cat litter box and whether it has completed the toileting.

The toilet status of a pet is automatically identified without manual intervention, thereby improving the response speed and accuracy of the system.

Specifically, the main control chip can be programmed to receive signals from the sensing module and perform logical determination.

Through the above step S100, monitoring of the toilet status of a pet in real time is achieved, providing trigger conditions for subsequent cleaning processes.

Step S200, controlling the cleaning device to perform a screening and cleaning process, when the current state is a state where toileting is completed.

As mentioned above, when the sensing module determines that the pet has completed the toileting (and has left), the cleaning device is activated to screen and clean the feces. The cleaning device starts working to separate and clean the feces from the cat litter.

This step realizes timely cleaning of feces, reduces the exposure time of feces in the environment, and reduces odor and pollution. Specifically, the cleaning device can be driven by a motor to perform cleaning actions according to a preset program, thereby realizing rapid cleaning of feces and reducing environmental sanitation problems.

Step S300, controlling the sealing device to open the opening of the connected garbage bag, and make it correspond to the position of the discharge outlet of the cleaning device, so as to receive the feces clumps discharged from the discharge outlet of the cleaning device through the opened opening of the garbage bag.

As mentioned above, when the cleaning device starts working, the sealing device is controlled to open the opening of the garbage bag so that it is aligned with the discharge outlet of the cleaning device. Feces can fall directly into the garbage bag, avoiding the scattering of feces and environmental pollution.

This step improves the accuracy of feces collection and reduces secondary pollution during the cleaning process.

The opening of the garbage bag is controlled by a mechanical arm or a similar mechanical device to ensure that it is aligned with the discharge outlet. Accurate collection of feces is achieved and environmental pollution is avoided.

Step S400, after completing the screening and cleaning process, closing the opening of the garbage bag that has received the feces clumps by the sealing device.

In this step, after the cleaning process is completed, the opening of the garbage bag is closed to ensure that the feces are sealed in the garbage bag. The feces in the garbage bag are sealed to prevent the odor and bacteria from spreading. This effectively controls the spread of odor and bacteria, protects environmental sanitation and the health of pets and family members.

The sealing device can be programmed to automatically close the opening of the garbage bag after the cleaning is completed.

Enclosed treatment of feces has been achieved and environmental sanitation problems are reduced.

Based on the sealing device provided in the embodiment of the present disclosure, it can be capable of fixing the garbage bag, adjusting the opening direction, position, angle, and opening size, and sealing the opening of the garbage bag after the screening and cleaning process is completed. The sealing can be a sealing for opening and disassembling, that is, when the screening and cleaning process needs to be carried out again and the garbage bag is not full, the opening of the garbage bag can be opened again to continue filling the feces clumps.

For example, it can be the following sealing device:
(1) basic frame: a frame structure used to fix and support the garbage bag to ensure the stability of the garbage bag during operation;
(2) garbage bag fixing mechanism: a garbage bag fixing clip or strap is provided on the frame to fix the garbage bag to prevent it from moving or slipping during operation;
(3) opening control mechanism: an opening control mechanism that can control the opening and closing of the opening of the garbage bag. This can be a simple hinge mechanism that allows the opening part of the garbage bag to rotate at a fixed point;
(4) position adjustment mechanism: in order to align the opening of the garbage bag with the discharge outlet of the cleaning device, a position adjustment mechanism is designed. This can be a slide rail system that allows the garbage bag to move along the slide rail to adjust the position of the opening;
(5) drive system: in order to achieve automatic control, a drive system such as a stepper motor or servo motor can be provided to control the rotation of the motor through programming, thereby driving the opening control mechanism and the position adjustment mechanism;
(6) sensor feedback system: an integrated sensor (such as an infrared sensor or a visual sensor) is used to detect the position and opening status of the garbage bag to ensure that the opening of the garbage bag is properly aligned and provide feedback signals when necessary;
(7) sealing mechanism: a sealing mechanism such as a zipper, clip or adhesive strip is designed at the opening of the garbage bag to close the opening of the garbage bag when feces collection is not required to prevent odor leakage;
(8) emergency stop and safety mechanism: to ensure the safety of operation, an emergency stop button and safety sensor are designed, such as automatically stopping the operation when an abnormal situation is detected;
(9) user interface: a user interface is provided, such as a touch screen or button, allowing the user to manually control the opening and closing of the garbage bag and adjust the position; and
(10) maintenance and cleaning: components that are easy to disassemble and clean are designed to facilitate regular maintenance and cleaning to ensure the long-term stable operation of the device.

The design of this sealing device takes into account automation, precise control and the convenience of the user operation, aiming to achieve an efficient and sanitary cleaning and collection process of the feces. By integrating advanced sensor technology and automated control, the device can ensure that the opening of the garbage bag is precisely aligned with the discharge outlet of the cleaning device and automatically closes after cleaning, reducing environmental pollution and odor emission.

### Embodiment 2

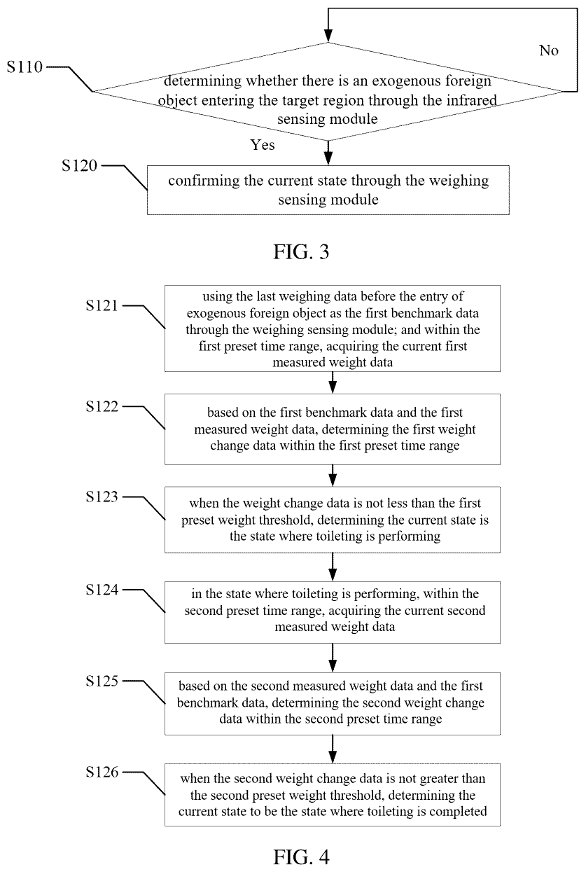

Referring to FIG. 3, embodiment 2 of the present disclosure provides a control method for a feces cleaning system, wherein the step S100 of determining the current state through a weighing sensing module and an infrared sensing module comprises following steps.

Step S110, determining whether there is an exogenous foreign object entering the target region through the infrared sensing module.

As mentioned above, an infrared sensing module is used to detect whether there is an object (such as a pet) entering the target region of the cat litter box.

The target region can be a pre-set region, and the target region can be monitored by an infrared sensing module, such as an infrared sensor, so as to determine whether there is a pet cat (exogenous foreign object) entering the region. If the pet cat (exogenous foreign object) enters the region, the current state can be confirmed.

In this step, the system can identify whether there is an object entering, which provides a prerequisite for subsequent weighing sensing. The infrared sensing module can quickly respond to the entry of an object and provide instant feedback to the system.

The main control chip can be programmed to receive the signal of the infrared sensing module and perform logical determination, thereby realizing monitoring of the target region in real time and providing a basis for the automatic operation of the system.

Step S120, if yes, then confirming the current state through the weighing sensing module.

As mentioned above, if the infrared sensing module detects the entry of exogenous foreign object, then the weighing sensing module is used to confirm the weight of the object to determine whether it is a pet going to the toilet. Because there is a possibility of wrong determination caused by non-pet objects entering the target region, for example, a paper box of the same size or similar size as the pet falls into the region.

In this step, the system can determine whether the pet is in the cat litter box and whether it has completed the toileting according to the weight change.

The weighing sensing module provides more accurate pet status information, improving the accuracy and reliability of the system. Specifically, the main control chip can be programmed to receive the signal of the weighing sensing module and make a comprehensive determination in combination with the signal of the infrared sensing module.

Accurate identification of the toilet status of a pet is achieved, providing accurate triggering conditions for the subsequent cleaning process.

If not, returning to execute step S110, and determining whether there is exogenous foreign object entering the target region through the infrared sensing module.

As mentioned above, if the infrared sensing module does not detect the entry of an object, or the weighing sensing module does not detect sufficient weight changes, the system will return to step S100 and continue to monitor the target region. In this step, the system remains in the monitoring state, waiting for the next possible entering of the pet.

The system can continuously monitor and will not start unnecessary cleaning processes due to a wrong determination, saving resources and improving efficiency.

Specifically, the loop logic can be implemented by programming until the correct signal is detected.

Continuous monitoring of the target region is achieved to ensure that the cleaning process is started only under the correct conditions.

In summary, the method provided in this embodiment, which combines the infrared sensing module and the weighing sensor to determine the toilet status of the pet, has significant advantages, wherein the infrared sensing module can quickly detect the action of the pet entering the cat toilet, reducing mis-operation, and the weighing sensor confirms the presence of the pet through precise weight changes, improving the accuracy of the determination. This dual sensing mechanism enhances the robustness of the system, and even when one sensor is interfered with, the other sensor can still provide key information to ensure stable operation of the system. In addition, this method reduces unnecessary weighing sensor activation by quickly eliminating interference from non-pet objects, thereby saving energy and improving efficiency. At the same time, it also improves the response speed of the system, optimizes the user experience, and reduces maintenance costs. In general, this method of combining infrared and weighing sensors not only improves the accuracy and reliability of the feces cleaning system, but also enhances its environmental adaptability and user satisfaction.

Further, referring to FIG. 4, the step S120 of confirming the current state through the weighing sensing module comprises following steps.

Step S121, using the last weighing data before the entry of exogenous foreign object as the first benchmark data through the weighing sensing module; and within the first preset time range, acquiring the current first measured weight data.

As mentioned above, before detecting that an object (such as a pet) enters the cat toilet, the last weighing data is recorded, and this data will be used as a benchmark for subsequent comparisons, thereby storing the weighing data before entry.

In this step, a benchmark weight is obtained for subsequent weight change comparisons. A stable starting point is provided for subsequent weight change analysis.

Step S122, based on the first benchmark data and the first measured weight data, determining the first weight change data within the first preset time range.

As mentioned above, within the set time range, the current weight data is measured and recorded. Weighing is performed within a specific time range to obtain the actual weight data after entering. Through real-time data capture, the weight change of the pet during the toileting process can be monitored.

A timer can be provided to trigger the weighing sensor to read data within a preset time interval.

Step S123, when the weight change data is not less than the first preset weight threshold, determining the current state is the state where toileting is performing.

As mentioned above, in this step, the difference between the benchmark data and the measured data is calculated to obtain the weight change. The difference between the two data points is calculated to obtain a weight change value, which indicates the weight reduction during the toileting process of the pet. The weight change can be used to determine whether the pet is toileting.

The formula can be used: first weight change data =first measured weight data −first benchmark data.

Step S124, in the state where toileting is performing, within the second preset time range, acquiring the current second measured weight data.

If the weight change reaches or exceeds the preset threshold, it is considered that the pet is toileting. Processing: comparing the weight change data with the preset threshold. The preset threshold can reduce wrong determination and improve the accuracy of the system.

Step S125, based on the second measured weight data and the first benchmark data, determining the second weight change data within the second preset time range.

The current weight data is measured and recorded again within another time range set after the pet goes to the toilet.

As mentioned above, weighing is performed within the preset time range after going to the toilet to obtain the actual weight data after going to the toilet. In this step, the weight change after the pet completes the toileting can be monitored to determine whether the toilet is completed. Another timer is set to trigger the weighing sensor to read data within a preset time interval after going to the toilet.

Step S126, when the second weight change data is not greater than the second preset weight threshold, determining the current state to be the state where toileting is completed.

As mentioned above, if the second weight change does not exceed the preset threshold, it is considered that the pet has completed the toileting. The second weight change data is compared with the preset threshold. Whether the pet has completed the toileting is determined.

By comparing the two weight changes, the toileting state of the pet can be determined more accurately.

Through this method, the system can accurately determine the toileting state of the pet and automatically start the cleaning process after the toileting is completed, thereby improving the intelligence and automation level of the feces cleaning system.

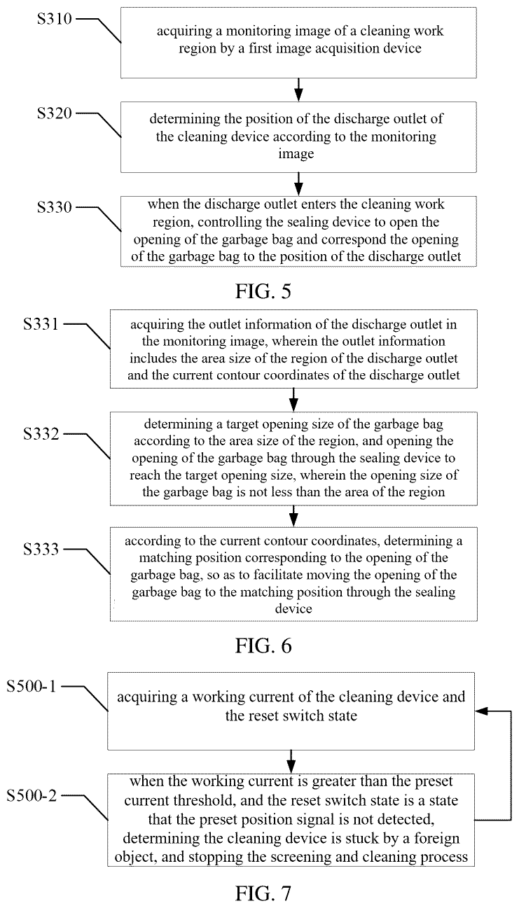

Further, referring to FIG. 5, the step S300 of controlling the sealing device to open the opening of the connected garbage bag, and make it correspond to the position of the discharge outlet of the cleaning device comprises following steps.

Step S310, acquiring the monitoring image of the cleaning work region through the first image acquisition device.

As mentioned above, the first image acquisition device can be a camera.

The cleaning work region mentioned above can be the region in the bin of the feces cleaning system, specifically, it can be all regions and spaces where feces and feces clumps are separated from the cleaning device and fall, flow out, and drop from the discharge outlet of the cleaning device.

It should be noted that, for the conventional cat litter box, cat toilet, the cleaning device can be of various different shapes, for example, including but not limited to a circular bin, a rectangle, or other irregular shapes, so that, in the conventional cat litter box, cat toilet, the cat litter mixed with feces moves inside the cleaning device through rotation and position adjustment, and is screened through the screen, and the larger volume of urine clumps, feces clumps and other materials are discharged from the discharge outlet into the large garbage bag.

However, since urine clumps and feces clumps, after being wrapped and stuck with cat litter, have different shapes of feces and urine after different cats eat different foods or in different physical conditions, and are also affected by air humidity, the fluidity of the feces clumps is poor. For example, in a region where the humidity is above 80%, the feces with a large water content have poor fluidity. During the screening process, they may not be able to enter the garbage bag as a whole, but may break during the screening process. Some feces clumps cannot fall, while another part of the urine clumps falls out of the discharge outlet, but does not enter the garbage bag, but falls into the internal structure of the cleaning device. In the long run, a large number of cat litter clumps containing feces and urine enter inside the machine and cannot be cleaned out, resulting in a heavy odor, and the cat litter box as a whole will still have a large odor when there is not much garbage in the garbage bag.

To avoid the above situation, in this embodiment, a method for controlling the sealing device to correspond the opening of the garbage bag to the position of the discharge outlet of the cleaning device is provided.

In step S310, an image acquisition device (such as a camera) is used to obtain a real-time image in the cleaning work region. The image acquisition device is used to monitor the cleaning work region in real time and capture image data. A real-time image of the cleaning work region is obtained for subsequent analysis.

The image data provides intuitive visual information, which helps to accurately determine the position of the discharge outlet.

Specifically, an image acquisition device such as a camera can be mounted, and corresponding image processing software can be configured.

Step S320, determining the position of the discharge outlet of the cleaning device according to the monitoring image.

As mentioned above, the collected image is analyzed to identify and determine the precise position of the discharge outlet of the cleaning device. Image processing algorithm is used to analyze the image, identify the characteristics and position of the discharge outlet, and obtain the precise coordinates or position information of the discharge outlet.

Automated position recognition improves the response speed and accuracy of the system.

Specifically, computer vision technology such as edge detection, feature matching or machine learning algorithm can be used to identify the position of the discharge outlet.

Step S330, when the discharge outlet enters the cleaning work region, controlling the sealing device to open the opening of the garbage bag and correspond the opening of the garbage bag to the position of the discharge outlet.

As mentioned above, the cleaning device changes position synchronously with the screening and cleaning process, so as to achieve the screening of cat litter and feces therein. The movement mode of the cleaning device is related to the different structures of the cat toilet. For example, there is a spherical bin in the middle on the market, which is equipped with a filter. When cleaning, the spherical bin will rotate, and the position of the discharge outlet will change with the rotation of the spherical bin. When it moves to the bottom, the feces screened out will fall into the garbage bag below through the discharge outlet through gravity.

However, during the rotation process, the discharge outlet gradually adjusts the angle and gradually docks with the opening of the garbage bag. In this process, there will be a such angle, and the discharge outlet is not facing the opening of the garbage bag. At this time, if there is feces with high fluidity in the spherical bin, they will fall directly from the discharge outlet to the space outside the opening region of the garbage bag.

Therefore, in this embodiment, when the discharge outlet enters the cleaning work region by moving, at this time, the opening of the garbage bag can be controlled by the system to open, so as to avoid the smell of feces which has presented in the garbage bag from being released in advance and reduce the time of smell release. On the other hand, the opening can be opened only when the discharge outlet is close to the position of the opening of the garbage bag to avoid garbage and feces falling into the region outside the garbage bag.

For example, when the system confirms through images that the discharge outlet has entered the cleaning work region, the sealing device is controlled to action, so as to open the opening of the garbage bag, and adjust the position to align it with the discharge outlet. According to the position information of the discharge outlet, the mechanical device is controlled to adjust the position and opening/closing state of the opening of the garbage bag.

The opening of the garbage bag is accurately opened and positioned below the discharge outlet to receive the discharged feces clumps.

This step method can ensure that the feces clumps fall directly into the garbage bag, avoiding spillage and environmental pollution, and improving the cleaning efficiency.

The mechanical device of the opening of the garbage bag can be controlled by a servo motor or a stepper motor, and automatically adjusted according to the position information.

The specific implementation method and algorithm can be the following method:
image acquisition: configuring a high-resolution camera to collect images of the cleaning work region regularly or in real time;
image preprocessing: performing preprocessing operations such as denoising and enhancement on the collected images to improve the accuracy of subsequent processing;
feature recognition: using image processing algorithms (such as Haar features, HOG features, and deep learning models) to identify the features and position of the discharge outlet;
position calculation: calculating the precise position coordinates of the discharge outlet based on the identified feature points;
mechanical control: according to the calculated position coordinates, the mechanical device (such as a servo motor) that controls the opening of the garbage bag is adjusted accordingly; and
synchronous operation: when the discharge outlet enters the cleaning work region, the opening of the garbage bag is opened synchronously and the position is adjusted to ensure that the feces clumps can fall accurately into the garbage bag.

Through this method, the system can automatically and accurately control the opening of the garbage bag to correspond to the position of the discharge outlet of the cleaning device, thereby improving the efficiency and sanitation of feces cleaning. This automated control method reduces manual intervention and improves the intelligence level of the system.

Further, referring to FIG. 6, the step S330 of controlling the sealing device to open the opening of the garbage bag and correspond the opening of the garbage bag to the position of the discharge outlet comprises following steps.

Step S331, acquiring the outlet information of the discharge outlet in the monitoring image, wherein the outlet information includes the area size of the region of the discharge outlet and the current contour coordinates of the discharge outlet.

The above step further refines how to control the sealing device to correspond the opening of the garbage bag to the position of the discharge outlet of the cleaning device, and involves the adjustment of the size of the opening of the garbage bag.

First, extracting relevant feature information of the discharge outlet from the monitoring image of the cleaning work region acquired by the first image acquisition device. Using image processing technology to identify and extract the area size of the region and contour coordinates of the discharge outlet, so as to obtain the specific size and position information of the discharge outlet.

This step enables the system to accurately adjust the opening of the garbage bag according to the actual size and position of the discharge outlet. Specifically, image recognition algorithms such as edge detection, region growth or deep learning can be used to extract outlet information.

Step S332, determining a target opening size of the garbage bag according to the area size of the region, and opening the opening of the garbage bag through the sealing device to reach the target opening size, wherein the opening size of the garbage bag is not less than the area of the region.

In this step, the target size of the opening of the garbage bag is set according to the area size of the region of the discharge outlet. The area of the region of the discharge outlet is compared with the opening size of the garbage bag to ensure that the opening of the garbage bag is not less than the area of the discharge outlet, so as to determine the target size to which the garbage bag needs to be opened.

It is ensured that the opening of the garbage bag can completely cover the discharge outlet to avoid feces spillage.

Specifically, the target opening size can be determined using the formula: target opening size=max (area of the region of the discharge outlet, current opening size).

Then, the sealing device is controlled to adjust the opening of the garbage bag to make it reach the desired target opening size. The opening of the garbage bag can be adjusted by driving an actuator (such as a motor) according to the target opening size. Thus, the opening of the garbage bag is adjusted to a size suitable for the size of the discharge outlet.

This step improves the adaptability and reliability of the system and ensures that discharge outlets of different sizes can be properly docked. The opening size of the garbage bag can be adjusted by precisely controlled an actuator such as a servo motor or a stepper motor.

Step S333, according to the current contour coordinates, determining a matching position corresponding to the opening of the garbage bag, so as to facilitate moving the opening of the garbage bag to the matching position through the sealing device.

In the above, the matching position of the opening of the garbage bag is determined based on the contour coordinates of the discharge outlet. The relative position between the contour coordinates of the discharge outlet and the opening of the garbage bag is calculated, and the moving path is determined, so as to obtain the specific position to which the opening of the garbage bag needs to be moved.

This step can ensure that the opening of the garbage bag can be accurately aligned with the discharge outlet to achieve accurate docking.

Specifically, coordinate transformation and path planning algorithms can be used to determine the movement path of the garbage bag.

The sealing device is controlled to move the opening of the garbage bag to a matching position corresponding to the discharge outlet. According to the coordinates of the matching position, the actuator (such as a mobile platform or a robotic arm) is driven to move the opening of the garbage bag.

Results: the opening of the garbage bag is accurately moved below the discharge outlet, ready to receive the discharged feces.

The method in this step realizes the automatic alignment and movement of the opening of the garbage bag, and improves the degree of automation of the system.

The opening of the garbage bag can be moved to a predetermined position using an actuator such as a motor and a guide rail system or a robotic arm.

For example, first, image processing technology is used to extract feature information of the discharge outlet, such as using the OpenCV library for image analysis. Then, the contour and region of the discharge outlet are matched by a pattern recognition algorithm to determine its position and size. An algorithm is written to compare the size of the region of the discharge outlet with the size of the opening of the garbage bag to ensure that the opening of the garbage bag is large enough. A control algorithm is designed to drive the servo motor to adjust the size of the opening of the garbage bag and move the opening of the garbage bag to the correct position. Sensor feedback information is used for closed-loop control to ensure accurate adjustment of the opening of the garbage bag.

Through this method, the system can automatically adjust the size and position of the opening of the garbage bag to adapt to discharge outlets of different sizes, ensure that feces can accurately fall into the garbage bag, and improve the efficiency and accuracy of the feces cleaning system.

### Embodiment 3

Referring to FIG. 7, embodiment 3 of the present disclosure provides a control method for a feces cleaning system. Based on embodiment 1, the step S200, after controlling the cleaning device to perform the screening and cleaning process, further comprises following steps.

Step S500-1, acquiring a working current of the cleaning device and the reset switch state.

As mentioned above, after the cleaning device performs the screening and cleaning process, the working current of the cleaning device is measured and obtained. Whether the reset switch can detect the preset position signal is detected to confirm whether the cleaning device is in a normal position.

The current sensor is used to monitor the current consumption of the cleaning device in real time. The state of the reset switch is read to determine whether the cleaning device has completed a cleaning cycle and reset.

The abnormal increase in current may be caused by mechanical blockage or overload, and monitoring current can be used as an important indicator for determining the state of the device. The reset switch provides feedback on the mechanical position, which helps to detect whether the cleaning device is stuck or fails to reset correctly.

Specifically, the current sensor can be integrated in the circuit, and the data can be transmitted to the control system for analysis. A reset switch is mounted on the cleaning device and connect its signal to the control system.

Step S500-2, when the working current is greater than the preset current threshold, and the reset switch state is a state that the preset position signal is not detected, determining the cleaning device is stuck with a foreign object, and stopping the screening and cleaning process, and returning to execute the step S500-1 to obtain the working current of the cleaning device and the reset switch state.

As mentioned above, when the monitored current exceeds the safety threshold and the reset switch display device is not reset, the system determines that the cleaning device may be stuck with a foreign object, compares the actual working current with the preset current threshold, and analyzes the state of the reset switch. If both conditions are met at the same time, the system determines that the cleaning device is faulty.

This dual determination mechanism improves the accuracy of the detection of the system on abnormal conditions, and measures can be taken in time to prevent further damage of the device. The logics of current threshold comparison and reset switch state analysis are achieved by programming, and corresponding fault determination conditions are set.

When it is determined that the cleaning device is stuck with a foreign object, that is, there may be a cat stuck situation, it is necessary to stop the screening and cleaning process. When the system determines that the cleaning device is stuck with a foreign object, the cleaning process is stopped immediately. A stop signal is sent to the cleaning device to interrupt its operation.

The cleaning device stops working, avoiding possible damage of the device and safety accidents that the pet cat is stuck. Stopping the operation in time can protect the device from damage and prevent the fault from further expanding.

Returning to execute to obtain the working current of the cleaning device and the reset switch state, that is, after stopping the cleaning process, the system returns to the monitoring state and continues to monitor the working current and the reset switch state. The system returns to step S500-1 and continues to monitor the state of the cleaning device.

The system maintains continuous monitoring of the state of the cleaning device until the problem is solved or manually intervened. Continuous monitoring helps to find problems in time and take corresponding measures, thereby improving the safety and reliability of the system.

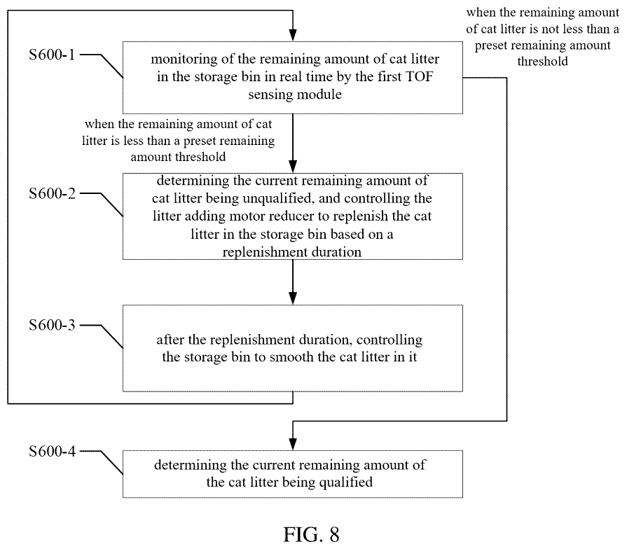

Further, referring to FIG. 8, the control method of the feces cleaning system further comprises following steps.

Step S600-1, monitoring of the remaining amount of cat litter in the storage bin in real time by the first TOF sensing module.

As above mentioned, the TOF (Time of Flight) sensing module is used to monitor the remaining amount of cat litter in the storage bin where the cat litter is stored in real time. The TOF sensing module calculates the distance by emitting light pulses and measuring the time of reflection back, thereby acquiring the remaining amount of cat litter. The real-time remaining data of cat litter is obtained.

It is possible to know the remaining amount of cat litter in time and provide a basis for subsequent replenishment decisions. Current method: mounting the TOF sensing module and aligning it with the storage bin, and reading the data of the sensing module through programming.

Step S600-2, when the remaining amount of cat litter is less than the preset remaining amount threshold, determining the current remaining amount of cat litter unqualified, and controlling the litter adding motor reducer to replenish the cat litter in the storage bin based on a replenishment duration.

In the above, the monitored remaining amount of cat litter is compared with the preset threshold to determine whether the cat litter needs to be replenished. It is necessary to compare the remaining amount of cat litter with the preset minimum remaining amount threshold. If the remaining amount of cat litter is lower than the threshold, the replenishment process is triggered. Ensure that the amount of cat litter is always sufficient to avoid affecting the cleaning effect due to insufficient cat litter.

Step S600-3, after the replenishment duration, controlling the storage bin to smooth the cat litter in it, and returning to execute the step S600-1 of monitoring the remaining amount of cat litter in the storage bin in real time through the first TOF sensing module.

When the remaining amount of cat litter is insufficient, the litter adding motor reducer is controlled to add cat litter to the storage bin, and the replenishment duration is based on the preset value. The litter adding motor reducer is activated, and cat litter is added to the storage bin according to the preset replenishment duration, so that the amount of cat litter in the storage bin is replenished.

The automated replenishment process ensures the stability of the amount of cat litter and reduces manual intervention.

As mentioned above, after the replenishment duration, the storage bin is controlled to smooth the cat litter therein. After the cat litter is replenished, the control device makes the cat litter smooth in the storage bin for the next use. A smoothing device (such as a scraper or a roller) is used to smooth the cat litter. The cat litter is smoothed and the storage bin is ready.

Smoothing the cat litter can improve the cleaning efficiency and ensure that the feces can be effectively covered.

A smoothing device is designed and mounted, and its operation is controlled through a control system. For example, the cleaning device-ball bin can be repeatedly rotated within a certain angle range to achieve the effect of smoothing the cat litter added in the ball bin.

As mentioned above, after smoothing the cat litter, the TOF sensing module continues to monitor the remaining amount of the cat litter to form a cycle.

Step S600-4, when the remaining amount of the cat litter is not less than the preset remaining amount threshold, determining the current remaining amount of the cat litter to be qualified.

At this time, there is no need to continue processing, and step S600-1 can also be returned to repeat the monitoring step circularly.

As mentioned above, if the monitored remaining amount of the cat litter is not less than the preset threshold, it is considered that the cat litter amount is sufficient. Reasoning: comparing the remaining amount of the cat litter with the preset threshold again. If the remaining amount of the cat litter is sufficient, no further replenishment is required. Excessive replenishment of cat litter is avoided and resources are saved.

Through this method, the feces cleaning system can automatically monitor the remaining amount of the cat litter and replenish it when necessary, ensuring the stability and continuity of the cleaning effect, while reducing manual intervention and improving the intelligence level of the system.

### Embodiment 4

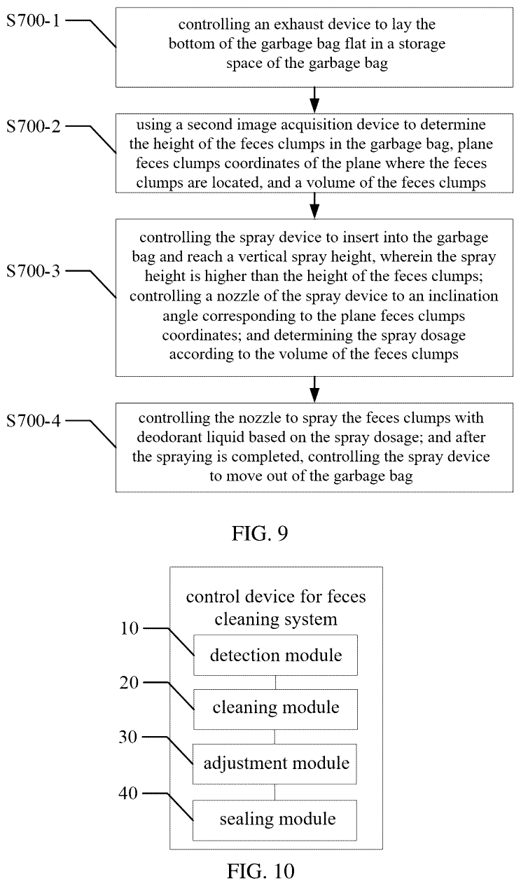

Referring to FIG. 9, embodiment 4 of the present disclosure provides a control method for a feces cleaning system. Based on embodiment 1, before closing the opening of the garbage bag that has received the feces clumps by the sealing device, it further includes following steps.

Step S700-1, controlling an exhaust device to lay the bottom of the garbage bag flat in a storage space of the garbage bag.

The exhaust device is used to lay the bottom of the garbage bag flat in the storage space of the garbage bag, so that the feces clumps can directly fall into the flattened garbage bag: generating negative pressure through the exhaust device, unfolding the bottom of the garbage bag and fitting it in the storage space. The flat bottom of the garbage bag provides a larger space for the garbage bag, which can prepare for the reception of the feces clumps on the one hand, and perform the deodorization function in this embodiment on the other hand.

It should be noted that in conventional technology, some cat toilets and pet toilets do have a certain deodorizing function. For example, in the A brand max model product, a deodorizing solid substance is placed, but the substance has poor performance in releasing deodorizing substances and also has the defect of attracting cockroaches and other insects; in the A brand pro product, a sprayer for spraying is provided. After the deodorant liquid is loaded, the deodorant liquid can be sprayed under the pre-set logic of the APP. Specifically, the deodorant liquid is sprayed on the surface of the open garbage bag through the sprayer.

However, the defect of this sprayer is that it can only spray indiscriminately within a limited range according to the location of the sprayer. It should be noted that since the discharge outlet and the opening of the garbage bag are both large, after the feces and feces clumps fall into it, they are not evenly spread in the garbage bag from bottom to top, but according to the factors such as its fluidity, air humidity, cat litter type (mineral litter, tofu litter, mixed litter, glass litter, etc.), feces state, etc., it often occurs that there are more urine clumps and feces clumps in some regions and fewer urine clumps and feces clumps in other regions. For example, there is a 20 cm high feces clumps in the upper left corner, and there is no or little cat litter and feces clumps in other regions, namely the upper right corner, the lower right corner, the lower left corner, and the middle. In this case, if the spraying of the deodorant liquid at a fixed position is still adopted, some positions that do not need to be sprayed (such as the position where there is no urine clumps, feces clumps, or scattered cat litter) will be sprayed with deodorant liquid, while the regions with a large amount of cat litter, much cat litter and urine clumps will only be sprayed with less deodorant liquid because of the wide spraying at a fixed position, and it is not possible to achieve targeted positioning spraying of the feces and urine clumps therein.

To solve this defect, in this embodiment, a control method for flexible positioning spraying of deodorant liquid is provided, thereby adding additional steps for feces clumps processing in the system, including the operation methods of laying garbage bags, measuring feces clumps, and spraying deodorant liquid.

The bottom and the outside of the garbage bag are evacuated by the exhaust device, so that the garbage bag can be unfolded and laid flat to increase the internal space of the garbage bag. On the one hand, it is ensured that the feces clumps fall directly into the garbage bag to avoid spillage and pollution; on the other hand, it is possible to further locate and measure the urine clumps and feces clumps in it.

Step S700-2, using a second image acquisition device to determine the height of the feces clumps in the garbage bag, plane feces clumps coordinates of the plane where the feces clumps are located, and a volume of the feces clumps.

In the above, the second image acquisition device (such as a movable camera) is used to obtain the image of the feces clumps in the garbage bag, and analyze the height, position and volume of the feces clumps. For example, it can be an Intel 3D depth camera, which can be used to adjust the angle to shoot one or more images, so as to capture the feces clumps images based on the image acquisition device, and the characteristic information of the feces clumps is extracted through image processing technology.

Through this step, the height (which can be a relative height), position (pixel coordinates) and volume data (occupied space size) of the feces clumps can be obtained, providing a basis for the subsequent spraying operation.

The spraying operation is accurately controlled to ensure that the deodorant liquid covers the target feces clumps evenly and in a targeted manner.

Computer vision technology, such as stereo vision or deep learning algorithm, can be used to analyze the characteristics of the feces clumps.

Step S700-3, controlling the spray device to insert into the garbage bag and reach a vertical spray height, wherein the spray height is higher than the height of the feces clumps; controlling a nozzle of the spray device to an inclination angle corresponding to the plane feces clumps coordinates; and determining the spray dosage according to the volume of the feces clumps.

As mentioned above, the nozzle of the spray device is inserted into the garbage bag and adjusted to a vertical spray height higher than the height of the feces clumps. The movement of the spray device is mechanically controlled so that its nozzle reaches the specified spray height.

The nozzle is positioned above the feces clumps and is ready for spraying. The deodorant liquid is ensured that can cover the entire feces clumps to improve the deodorization effect.

The lifting and lowering of the spray device can be controlled by using a servo motor or a stepper motor.

As mentioned above, the nozzle of the spray device is adjusted to the correct inclination angle so that the deodorant liquid can be accurately sprayed on the target feces clumps. According to the plane coordinates of the feces clumps, the required inclination angle is calculated, and the nozzle is adjusted, so that the nozzle can be accurately positioned to prepare for precise spraying. The accuracy of spraying is improved and waste of deodorant liquid is avoided.

In the above, the dosage of deodorant liquid to be sprayed is determined according to the volume of the feces clumps. The volume of the feces clumps is calculated, and the spray dosage is determined according to the preset ratio, so that a suitable spray dosage can be obtained to ensure the deodorization effect. The amount of deodorant liquid used is accurately controlled to avoid waste.

For example, it can be calculated by the formula:
Spray dosage=k×feces clumps volume;
wherein k represents a proportional constant determined according to the experiment.

Step S700-4, controlling the nozzle to spray the feces clumps with deodorant liquid based on the spray dosage; and after the spraying is completed, controlling the spray device to move out of the garbage bag.

According to the calculated spray dosage, the nozzle is controlled to spray the deodorant liquid on the feces clumps. The spraying amount and time of the nozzle are accurately controlled to achieve the predetermined spray dosage. The feces clumps are evenly sprayed with deodorant liquid to achieve the deodorizing effect. Deodorizing efficiency is improved and environmental sanitation is improved.

After spraying, the spray device is controlled to move out of the garbage bag, that is, the spray device is controlled to move out of the garbage bag, and the garbage bag is prepared to be closed.

The servo motor or stepper motor can be used to control the in and out of the spray device.

In this way, the feces cleaning system can not only effectively clean the feces clumps, but also improve environmental sanitation and reduce odor by precisely controlling the spraying of deodorant liquid. This automated processing process improves the intelligence level of the system, reduces manual intervention, and improves efficiency and safety.

In addition, referring to FIG. 10, a control device for a feces cleaning system is also provided in the embodiment of the present disclosure, comprising:
a detection module 10, used to determine a current state through a weighing sensing module and an infrared sensing module;
a cleaning module 20, used to control the cleaning device to perform a screening and cleaning process if the current state is a state where toileting is completed;
an adjustment module 30, used to control the sealing device to open the opening of the connected garbage bag, and make it correspond to the position of the discharge outlet of the cleaning device, so as to receive the feces clumps discharged through the discharge outlet of the cleaning device through the opened opening of the garbage bag; and
a sealing module 40, used to close the opening of the garbage bag that has received the feces clumps through the sealing device after the screening and cleaning process is completed.

It can be understood that the device of this embodiment corresponds to the control method of the feces cleaning system of the above embodiment, and the optional items in the above embodiment are also applicable to this embodiment, so they will not be described again here.

In addition, in the embodiment of the present disclosure, a control system of a feces cleaning system is also provided, and the control system of the feces cleaning system includes a processor and a memory, the memory stores a computer program, and the processor is used to execute the computer program to implement the control method of the feces cleaning system described in any of the above embodiments.

The processor can be an integrated circuit chip with signal processing capabilities. The processor can be a general-purpose processor, including a central processing unit (CPU), a graphics processing unit (GPU), a network processor (NP), a digital signal processor (DSP), an application-specific integrated circuit (ASIC), a field programmable gate array (FPGA) or at least one of other programmable logic devices, discrete gates or transistor logic devices, and discrete hardware components. The general-purpose processor can be a microprocessor or the processor can also be any conventional processor, etc., which can implement or execute the methods, steps and logic block diagrams disclosed in the embodiments of the present disclosure.

The memory can be, but is not limited to, a random access memory (RAM), a read-only memory (ROM), a programmable read-only memory (PROM), an erasable programmable read-only memory (EPROM), an electrically erasable read-only memory (EEPROM), etc. The memory is used to store computer programs, and the processor can execute the computer program accordingly after receiving the execution instruction.

In addition, in the embodiment of the present disclosure, a feces cleaning system is also provided, comprising a main control chip, an electronic sensing safety system, an automatic cleaning system, an automatic litter adding system and an automatic packaging system.

The main control chip communicates with the mobile device and is connected to the electronic sensing safety system, the automatic cleaning system, the automatic litter adding system and the automatic packaging system; the electronic sensing safety system includes an infrared sensing module, a weighing sensing module, a radar sensing module and a TOF sensing module; the automatic cleaning system includes: a drum motor reducer, a sealing cover motor reducer, a sterilization and deodorization module, a stall current detection module and a reset switch.

The automatic litter adding system includes a litter adding motor reducer and a drum motor reducer; a stall current detection module and a reset switch.

The present disclosure also provides a computer-readable storage medium for storing the computer program used in the above-mentioned computer device. For example, the computer-readable storage medium may include, but is not limited to, various media that can store program codes, such as U disk, a mobile hard disk, a read-only memory (ROM), a random access memory (RAM), a magnetic disk or an optical disk.

In the several embodiments provided in the present disclosure, it should be understood that the disclosed devices and method may also be implemented in other ways. The devices embodiments described above are merely schematic. For example, the flowcharts and structure diagrams in the drawings show the possible architecture, functions and operations of the devices, method and computer program product according to the multiple embodiments of the present disclosure. In this regard, each box in the flowchart or block diagram may represent a module, a program segment or a part of the code, and the module, program segment or a part of the code contains one or more executable instructions for implementing the specified logical functions. It should also be noted that in an alternative embodiment, the functions marked in the box may also occur in an order different from that marked in the drawings. For example, two consecutive boxes can actually be executed substantially in parallel, and they may sometimes be executed in the opposite order, depending on the functions involved. It should also be noted that each box in the structure diagram and/or flowchart, and the combination of boxes in the structure diagram and/or flowchart, can be implemented by a dedicated hardware-based system that performs the specified function or action, or can be implemented by a combination of dedicated hardware and computer instructions.

In addition, the functional modules or units in various embodiments of the present disclosure can be integrated together to form an independent part, or each module can exist separately, or two or more modules can be integrated to form an independent part.

If the function is implemented in the form of a software functional module and sold or used as an independent product, it can be stored in a computer-readable storage medium. Based on this understanding, the technical solution of the present disclosure is essentially or the part that contributes to the prior art or the part of the technical solution can be embodied in the form of a software product, the software product of the computer is stored in a storage medium and includes a number of instructions for a computer device (which can be a smart phone, a personal computer, a server, or a network device, etc.) to perform all or part of the steps of the method described in various embodiments of the present disclosure. The aforementioned storage media include: U disk, mobile hard disk, read-only memory (ROM), random access memory (RAM), disk or optical disk and other media that can store program code.

The above is only specific embodiments of the present disclosure, but the protection scope of the present disclosure is not limited to this. Any skilled familiar with the art can easily think of changes or replacements within the technical scope disclosed in the present disclosure, which should be covered within the protection scope of the present disclosure.

1. A control method of a feces cleaning system, wherein the control method comprises:
determining a current state through a weighing sensing module and an infrared sensing module;
when the current state is a state where toileting is completed, controlling a cleaning device to perform a screening and cleaning process;
controlling a sealing device to open an opening of a connected garbage bag, and make the opening correspond to a position of a discharge outlet of the cleaning device, so as to receive feces clumps discharged through the discharge outlet of the cleaning device through the opened opening of the garbage bag; and
after the screening and cleaning process is completed, closing the opening of the garbage bag that has received the feces clumps by the sealing device.

2. The control method of a feces cleaning system according to claim 1, wherein the determining a current state through a weighing sensing module and an infrared sensing module comprises:
determining whether there is exogenous foreign object entering a target region through the infrared sensing module;
if yes, confirming the current state through the weighing sensing module;
if no, returning to execute the determining whether there is exogenous foreign object entering a target region through the infrared sensing module.

3. The control method of a feces cleaning system according to claim 2, wherein the confirming the current state through the weighing sensing module comprises:
using a last weighing data before entry of the exogenous foreign object as a first benchmark data through the weighing sensing module; and within a first preset time range, acquiring a current first measured weight data;
based on the first benchmark data and the first measured weight data, determining a first weight change data within the first preset time range;
when the weight change data is not less than a first preset weight threshold, determining the current state is a state where toileting is performing;
in the state where toileting is performing, within a second preset time range, acquiring a current second measured weight data;
based on the second measured weight data and the first benchmark data, determining a second weight change data within the second preset time range; and
when the second weight change data is not greater than a second preset weight threshold, determining the current state is the state where toileting is completed.

4. The control method of a feces cleaning system according to claim 1, wherein the controlling a sealing device to open an opening of a connected garbage bag, and make the opening correspond to a position of a discharge outlet of the cleaning device comprises:
acquiring a monitoring image of a cleaning work region by a first image acquisition device;
determining a position of the discharge outlet of the cleaning device according to the monitoring image; and
when the discharge outlet enters the cleaning work region, controlling the sealing device to open the opening of the garbage bag and correspond the opening of the garbage bag to the position of the discharge outlet.

5. The control method of a feces cleaning system according to claim 4, wherein the controlling the sealing device to open the opening of the garbage bag and correspond the opening of the garbage bag to the position of the discharge outlet comprises:
acquiring an outlet information of the discharge outlet in the monitoring image, wherein the outlet information comprises an area size of a region of the discharge outlet and current contour coordinates of the discharge outlet;
determining a target opening size of the garbage bag according to the area size of the region, and opening the opening of the garbage bag to reach the target opening size through the sealing device, wherein an opening size of the garbage bag is not less than the area of the region; and
determining a matching position corresponding to the opening of the garbage bag according to the current contour coordinates, so as to move the opening of the garbage bag to the matching position through the sealing device.

6. The control method of a feces cleaning system according to claim 1, wherein after the controlling a cleaning device to perform a screening and cleaning process, the control method further comprises:
acquiring a working current of the cleaning device and a reset switch state;
when the working current is greater than a preset current threshold, and the reset switch state is a state that a preset position signal is not detected, determining there is a foreign object stuck in the cleaning device, and stopping an executing of the screening and cleaning process, and returning to execute the acquiring a working current of the cleaning device and a reset switch state.

7. The control method of a feces cleaning system according to claim 1, wherein the control method of the feces cleaning system further comprises:
monitoring of a remaining amount of cat litter in a storage bin in real time by a first TOF sensing module;
when the remaining amount of cat litter is less than a preset remaining amount threshold, determining a current remaining amount of cat litter is unqualified, and controlling a litter adding motor reducer to replenish the cat litter in the storage bin based on a replenishment duration;
after the replenishment duration, controlling the storage bin to smooth the cat litter therein, and returning to execute the monitoring of a remaining amount of cat litter in a storage bin in real time by a first TOF sensing module; and
when the remaining amount of cat litter is not less than the preset remaining amount threshold, determining the current remaining amount of cat litter is qualified.

8. The control method of a feces cleaning system according to claim 1, wherein before the closing the opening of the garbage bag that has received the feces clumps by the sealing device, the control method further comprises:
controlling an exhaust device to lay a bottom of the garbage bag flat in a storage space of the garbage bag;
using a second image acquisition device to determine a height of the feces clumps in the garbage bag, plane feces clumps coordinates of a plane where the feces clumps are located, and a volume of the feces clumps;
controlling a spray device to insert into the garbage bag and reach a vertical spray height, wherein the spray height is higher than the height of the feces clumps;
controlling a nozzle of the spray device to an inclination angle corresponding to the plane feces clumps coordinates;
determining a spray dosage according to the volume of the feces clumps; and
controlling the nozzle to spray the feces clumps with deodorant liquid based on the spray dosage; and after the spray is completed, controlling the spray device to move out of the garbage bag.

9. A control device for a feces cleaning system, wherein the control device for the feces cleaning system comprises:
a detection module, configured to determine a current state through a weighing sensing module and an infrared sensing module;
a cleaning module, configured to control a cleaning device to perform a screening and cleaning process when the current state is a state where toileting is completed;
an adjustment module, configured to control a sealing device to open an opening of a connected garbage bag, and make the opening correspond to a position of a discharge outlet of the cleaning device, so as to receive the feces clumps discharged through the discharge outlet of the cleaning device through the opened opening of the garbage bag; and
a sealing module, configured to close the opening of the garbage bag that has received the feces clumps through the sealing device after the screening and cleaning process is completed.

10. A control system for a feces cleaning system, wherein the control system for the feces cleaning system comprises a processor and a memory, the memory stores a computer program, and the processor is configured to execute the computer program to implement the control method of a feces cleaning system according to claim 1.
